(19) United States
(12) Patent Application Publication
(10) Pub. No.: US 2002/0129332 A1
(43) Pub. Date: Sep. 12, 2002

(54) System for generating softskill simulation

(76) Inventor: Peter Svensson, Goteborg (SE)

Correspondence Address: BIRCH STEWART KOLASCH & BIRCH, PO BOX 747, FALLS CHURCH, VA, 22040-0747, US

(21) Appl. No.: 09/802,908

(22) Filed: Mar. 12, 2001

(51) Int. Cl. G06F 9/44

(52) U.S. Cl. 717/106

(57) ABSTRACT

The present invention relates to a computer system for generating softskill simulation code using a graphical interface for designing a structure of graphical elements representing possible events in a social interaction, preferably between two people, said graphical elements representing program code adapted to present information to a user and to receive information relating to decisions of the user. According to the invention, the structure of graphical elements includes a plurality of interconnected branches representing possible paths through the simulation, the particular path followed by a user being determined by said decisions. The system further comprises means for graphically linking a graphical element to at least one graphical subelement, representing a program code portion adapted to store information related to decisions made by the user in a memory area, and for graphically linking a graphical element to at least one graphical subelement, representing a program code portion adapted to read, from said memory area, information related to decisions previously made by said user, and to adapt said path depending on said information.

### TECHNICAL FIELD

The present invention relates to a computer system for generating softskill simulation code using a graphical interface for designing a structure of graphical elements representing possible events in a social interaction, preferably between two people, said graphical element representing program code adapted to present information to a user and to receive information relating to a decision of the user, such decisions determining a path through said network structure.

### TECHNICAL BACKGROUND

In many situations, it is important to train and maintain the ability of a person to interact with his/her environment, and especially other human beings in this environment. Such abilities are different from the hard skills related to factual learning and learning by doing, and rather relate to a persons softer qualities, such as saying the right thing at the right time. These qualities are sometimes referred to as “soft skills”, and the training of these skills is preferably performed by using a computer system to simulate interaction with other people, e.g. “softskill simulation”.

This type of simulation has for example been successfully used when training sales people, but an increasing demand for this type of training is expected in many different areas.

One area, where the potential for softskill simulation is especially large, is the area of e-learning, where the leaning situation itself often contributes to overlooking the soft qualities of the person learning. Many implementations of e-learning are today unsuccessful, as they fail to attract the user with reasonable human interaction.

When developing a softskill simulation, knowledge of the human mind and language are the basic input, resulting in patterns regarding how for example a verbal intercourse may develop, and how a given goal may be achieved. This material then needs to be programmed into a computer system, in order to be practically implemented as a training exercise.

However, this step of transforming the knowledge soft skills into a strict computer program causes problems. The people who have the knowledge of the human behavior (e.g. linguistics, psychologists, psychiatrists, etc) normally lack knowledge of computer programming and vice versa. Also, the computer programming technique is in itself a “hard” skill, creating an obstacle to the very purpose of the system, namely to create and present softskill simulations.

Although conventional software packages for softskill simulation design are based on a graphical interface, the graphical structure is linear, thereby limiting the programmer in his creative design. As the desired softskill simulation is based upon human interaction, it typically is best described as a more complex “tree” structure, where a simulation can diverge in several different paths. This “tree”-structure, possibly described on several flowcharts by e.g. a linguist or psychologist, must be transformed into the linear world of the software package by a programmer.

One solution to this problem is to generate program code to handle combinations of linear sequences, and their relationships. This is implemented in e.g. Macromedia's Director, using the high-level computer language Lingo. Another possibility is a further enhanced, but still linear, graphical design, where several linear structures can be combined. This is implemented in e.g. Macromedia's Authorware.

One particular feature, making the work of the programmer more complex, is the flow of information relating to the user's previous decisions, i.e. his/her “history” in the simulation. In order to filly reflect the interaction of a social interaction, such as a verbal intercourse, the path followed by the user should not only be influenced by the selection made in the currently active module, but rather by all previously made selections. In conventional simulation generation software packages, such as Macromedia's Director mentioned above, this may only be achieved by hard coding a number of conditional expressions in the computer code of the simulation. Although not a big problem for a computer programmer, this effectively alienates the simulation generation process from technically unskilled professionals involved in the softskill simulation development.

Although functional, and capable of accomplishing the softskill simulation, the above solutions still do not overcome the basic problem of making the softskill simulation design process available to the people having the required knowledge. Therefore, there is a need for a specialized technology for handling the specific needs associated with generation of softskill simulations.

### OBJECTS OF THE INVENTION

An object of the present invention is to provide a technology that facilitates the process of generating softskill simulations, making it easier, faster and with higher quality.

Another object of the invention is to provide a technology that is easy to handle for today's softskill training producers and other non-technicians.

Another object of the invention is to provide a technology that is technically flexible and compatible with other producers' softwares and file formats.

### SUMMARY OF THE INVENTION

These and other objects are achieved with a system of the kind mentioned by way of introduction, wherein said structure of graphical elements includes a plurality of interconnected branches representing possible paths through the simulation, the particular path followed by a user being determined by said decisions. The system further comprises means for graphically linking a graphical element to at least one graphical subelement, representing a program code portion adapted to store information related to decisions made by the user in a memory area, and for graphically linking a graphical element to at least one graphical subelement, representing a program code portion adapted to read, from said memory area, information related to decisions previously made by said user, and to adapt said path depending on said information.

The process of creating softskill simulation code typically comprises creating a structure of decision points, basically defining how a verbal intercourse may develop and lead to one of a plurality of outcomes. Each decision point represents a decision of a user, based on information available to the user at this point. As mentioned above, this structure has been transformed into linear sequences by a programmer, normally necessitating complicated coding on the programmers part.

According to the present invention, this design process is facilitated by an enhanced graphical design process, according to which the softskill programmer (or designer) can build a softskill simulation tree structure with several branches directly on the screen. As in conventional software packages, each decision point is represented by a graphical element associated with computer program code for performing the information exchange between system and user. The contents of each box relates e.g. to different things to say in a simulated intercourse, and the decision can consist of selecting one of said alternatives. The made selection influences which point is reached next. However, instead of limiting these boxes to linear relationships, they may be connected in an arbitrary fashion, resulting in a logical tree structure with several interconnected branches. This structural approach provides for a simple, graphically presentable way to design the foundation of a softskill simulation.

Also, there has been recognized a need for handling information flow throughout the structure, i.e. permitting the earlier decisions made by a user to influence the path he is currently following. This information handling has been regarded as too complex to be handled visually in any non-linear programming tool.

According to the invention, the graphical structure is therefore further improved, and includes subelements, associated with the graphical elements. These subelements represent program code portions that interact with an area in the system memory, reading and writing information about a user's actions and selections.

By inserting graphical representations of these code portions directly into the tree structure, the variables in the memory are used to transfer information through the tree structure. This information is used to trigger certain events and also for controlling a user's scoring

A great advantage with these graphically represented code portions is that the programmer does not need to be directly involved in the details of programming. Instead, the simulation can be “designed” in a graphical sense, enabling a closer relationship with the soft skills it is intended to simulate. In the following description, the term “designer” will therefore be used for the person creating a softskill simulation.

The hardships of transferring information from previously made decisions to the present decision point, is handled by continuously generating a structured memory area, containing variable settings for any desired information. The graphical interface gives the designer a good overview, enabling him to see relationships between decision points and to realize when information should be transferred between decision points.

### BRIEF DESCRIPTION OF THE DRAWINGS

These and other aspects of the invention will be apparent from the preferred embodiment more clearly described with reference to the appended drawings.

FIG. 1 schematically illustrates a system environment comprising a component according to the invention.

FIG. 2 illustrates a web implementation of a system according to the invention.

FIG. 3 illustrates a schematic tree structure of a softskill simulation according to the invention.

FIG. 4 illustrates the graphical representation of program code elements according to an embodiment of the invention.

FIG. 5 schematically illustrates the software structure of an embodiment of the invention.

FIG. 6 schematically illustrates the dynamic structure according to the invention.

FIG. 7 illustrates the user interface according to an embodiment of the invention.

### DETAILED DESCRIPTION OF A PREFERRED EMBODIMENT

A complete software environment adapted for softskill simulation basically needs to provide the following three functions:

Creation of simulations, including transferring the knowledge of human behaviour and dialog to the computer system, formulated as a complex set of actions and conditions.

Storage of simulations in a suitable computer supported environment, also providing administrative functionality of user accounts,

Active running of simulations in interaction with one or several users.

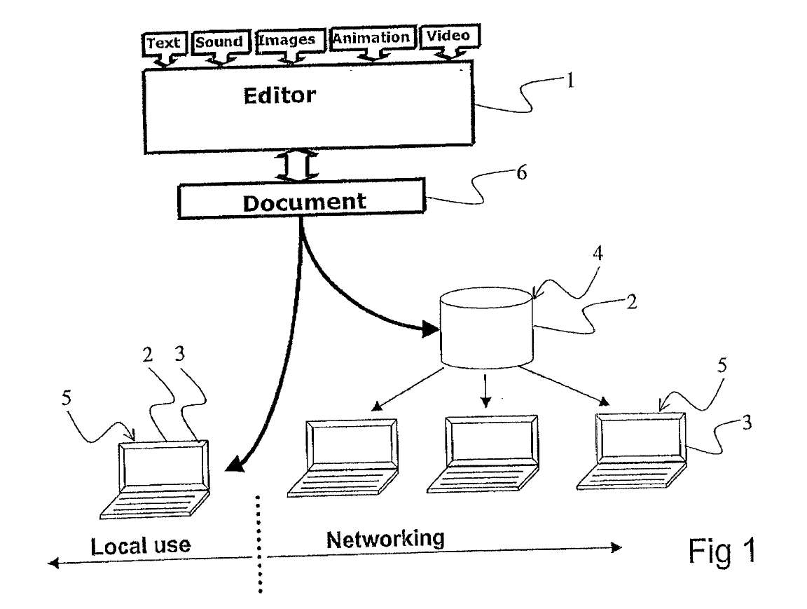

Such an environment is illustrated in FIG. 1, where the modules relating to the three functions mentioned above are referred to as editor 1, server 2 and player 3 respectively. The server is a set of scripts (PHP/ASP etc) to be used together with standard databases. Depending on whether the system is implemented in a network or locally, the server software 2 is installed on a network server 4 or on the hard disk of a work station 5. The player software 3 is installed locally on the terminal 5 of the user.

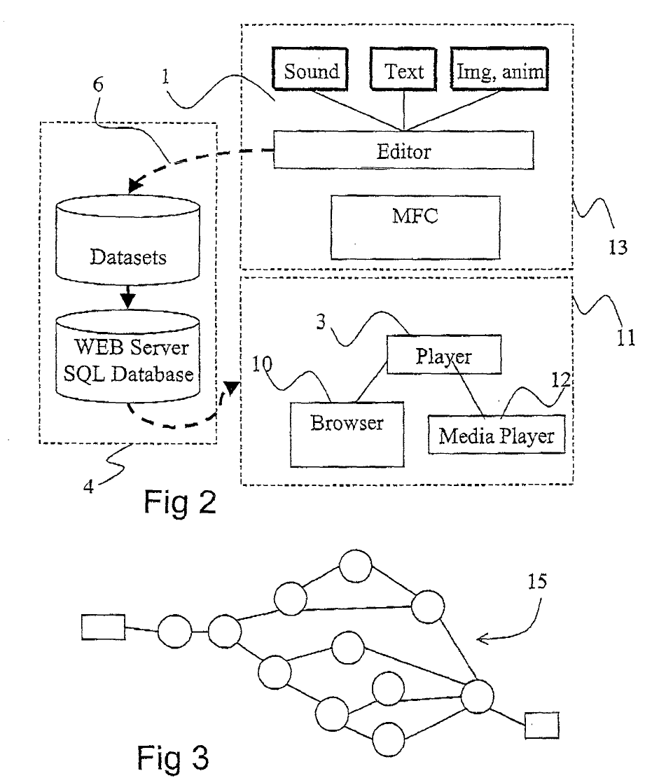

FIG. 2 illustrates how the system can be implemented in a Web server solution. Examples of possible server environments are MySQL (Linux based), Oracle and SQL Server (Windows Based). The server can support an LMS (Learning Management System), or be compatible with existing such systems. The player 3 is preferably a Plug-In to an Internet Browser 10, to be used in e.g. Explorer or Netscape Browsers installed in a Windows environment 11. The player 3 can utilize any known media player 12 to playback media contents such as images, animations or video clips.

The editor 1 is a software application for creating and modifying simulations. The application can be intended to be run on e.g. a Windows work station 13, in which case it is preferably built using Microsoft MFC as a base and follows the standard set by Microsoft for a Windows application. It is this editor application 1 that is the main topic of this patent application.

The editor application consists of a main program, with common functionality on a top-level layer. The main program handles all common activities normally found in a Windows application. The application is preferably a multi document application, making it possible to e.g. Copy/Paste over several documents. Among other things the functions include viewing options, allowing a programmer to select the level of detail displayed on the screen. None of this is considered to be new to the art, and is not further described.

The editor 1 is arranged to let the simulation designer use available media clips, text, images and sound, to create a simulation according to the current needs. The finished simulation is packaged in a file 6 of a specific format, adapted to be readable by the server and player software 2, 3.

A simulation designed in the editor 1 according to the invention preferably starts at one point and ends at one point. Between those start and ending points, the structure can be regarded as a “multi thread” flow where the path followed in each junction is a result of what action the user takes in that specific junction and what actions he has taken previously in the simulation. Such a flow structure is schematically illustrated in FIG. 3.

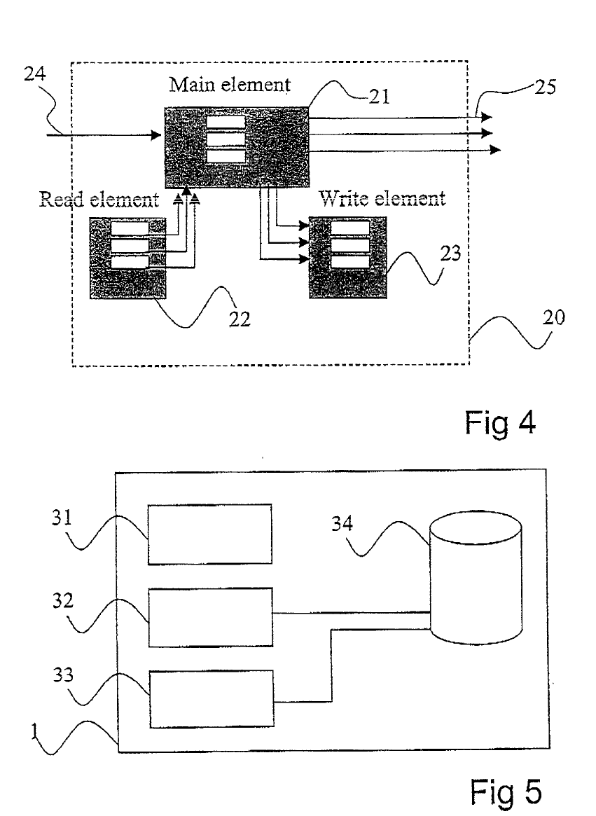

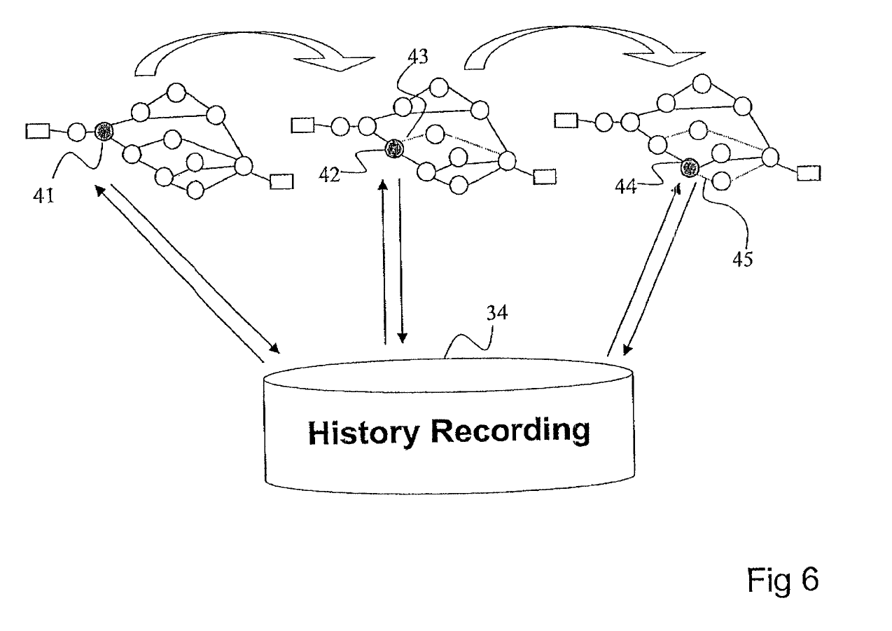

Reference is now made to FIGS. 4 and 5. During design of a simulation, each of the decision points is graphically displayed as a block 20 with one or several entrances 24, and one or several exits 25. A block can be displayed on a more detailed level, for example available to the designer by selecting a different view, whereby each block is divided in different graphical elements (see FIG. 4). A main element 21 is associated with program code portions 31 of the editor software 1 (see FIG. 5) adapted to display a piece of information to the user, and to receive a selection or decision from the user. In one simple case, the main element 21 is adapted to display a text box on the screen, with a number of alternative replies, to be selected by the user. Other examples of information include audio clips, video clips etc, and the decision from the user may be any form of action performed with an input device, such as a keyboard or mouse.

Each block 20 can further be linked to one or several graphical subelements 22, 23, associated with additional computer program code portions 32, 33 of the editor software 1, adapted to interact with a memory area 34 containing information about the users earlier decisions. A subelement can be of essentially two kinds;

A “read”-element 22 evaluates the values of variables in the memory, and adapts the contents of the main element in accordance with these values. The evaluation can be of simple TRUE/FALSE-type, including various Boolean operators. The result of the evaluation can for example affect which text the main element will display. A read element is illustrated graphically as being connected up streams the main element 21, (See FIG. 4)

A “write”-element 23 sets the values of variables in the memory depending on the action of the user, and stores competence data. A write element is illustrated graphically as being connected down streams the main element 21. (See FIG. 4.)

The editor 1 provides means for linking a main element to a subelement graphically, typically by letting the designer use a pointing device such as a mouse to insert main elements and subelements into a working area, and indicating which ones should be connected to each other. Naturally, the specifics of each graphical element can be edited, and the specific function of a subelement be defined. The details of this implementation is left in the hands of the skilled technician.

Pig 6 illustrates how the tree structure 15 changes dynamically during a run of a simulation. In step I, the user is presented with the information in block 41, and makes a selection. This selection, together with information from the “history recording” in the memory 34, results in the simulation proceeding to block 42. At the same time, information about the selection is stored in the memory 34.

When block 42 is reached, information from the memory 34 immediately results in one of the possible exits 43 from this block being shut. Again, information is presented to the user, and a selection is made, advancing the simulation to block 44, where again one of the exits 45 is shut.

It may appear limiting to the users ability to choose freely, that exits are shut in advance in this way, but note that this action only results from the 5 user's own actions. The difference from traditional navigation through a tree structure, is that a selection made earlier may influence your options later on. This gives the simulation designer a powerful tool for simulating hindsight etc.

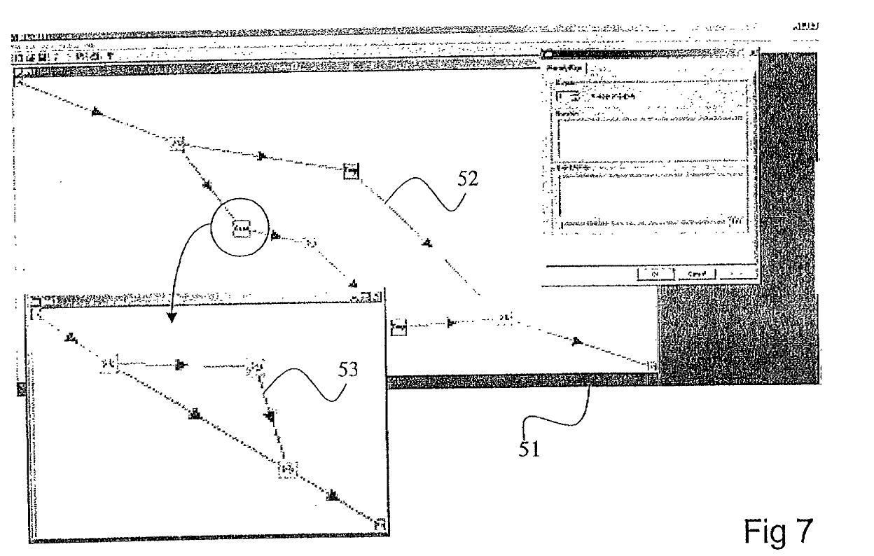

FIG. 7 illustrates how the user interface may be implemented. In order to help the simulation designer, the tree structure can be displayed at different levels, selectively hiding certain details. For example, the illustrated view 51 is a high level tree structure 52. A block in this view 51 may be double clicked to show a farther level of blocks 53. On the last level, the subelements become available, in a view resembling that of FIG. 4.

A system according to the present invention may be used in a variety of areas, also outside the field of interactive learning. For instance, it might be beneficiary in practical psychology or psychiatrics, for rehabilitating patients to a social environment. Common everyday situations may be simulated, and the patients actions can be graded to form part of a psychiatric evaluation.

1. Computer system for generating softskill simulation code using a graphical interface for designing a structure of graphical elements representing possible events in a social interaction, preferably between two people, said graphical elements representing program code adapted to present information to a user and to receive information relating to decisions of the user, said system being characterized in that said structure of graphical elements includes a plurality of interconnected branches representing possible determined by said decisions, and in that it further comprises means for graphically linking a graphical element to at least one graphical subelement, representing a program code portion adapted to store information related to decisions made by the user in a memory area, and for graphically linking a graphical element to at least one graphical subelement, representing a program code portion adapted to read, from said memory area, information related to decisions previously made by said user, and to adapt said path depending on said information.

2. System according to claim 1, wherein said memory area is located on a server in a network.

3. System according to claim 1, wherein said memory area is located on a work station.

4. System according to claim 1, wherein said subelements are visible on the graphical interface only when a specific viewing mode is selected.

5. System according to claim 1, wherein said decisions relate to selections in a multiple choice situation.

6. System according to claim 1, wherein said means for linking a graphical element to a subelement comprise a pointing device, connected to said graphical interface, allowing a designer to insert subelements into a working area.
